(19) United States
(12) Patent Application Publication
(10) Pub. No.: US 2013/0004115 A1
(43) Pub. Date: Jan. 3, 2013

(54) OPTICAL WAVEGUIDE CIRCUIT AND METHOD OF MANUFACTURING THE SAME, AND OPTICAL WAVEGUIDE CIRCUIT APPARATUS

(75) Inventors: Hiroshi KAWASHIMA, Tokyo (JP); Junichi Hasegawa, Tokyo (JP); Naoki Sato, Tokyo (JP)

(73) Assignee: Furukawa Electric Co., Ltd., Tokyo (JP)

(21) Appl. No.: 13/611,033

(22) Filed: Sep. 12, 2012

Related U.S. Application Data
(63) Continuation of application No. PCT/JP2012/055826, filed on Mar. 7, 2012.

(30) Foreign Application Priority Data
Mar. 24, 2011 (JP) 2011-066404

(51) Int. Cl. G02F 1/035; C03B 37/10

(52) U.S. Cl. 385/2; 65/378

(57) ABSTRACT

An optical waveguide circuit includes: an optical interferometer including an optical waveguide; and a heating unit that is disposed along at least a part of the optical waveguide included in the optical interferometer and performs heating of imparting, to the optical waveguide, reversible refractive index changes different from each other along two principal axes of refractive index of the optical waveguide and heating of imparting, to the optical waveguide, permanent refractive index changes different from each other along the two principal axes of refractive index of the optical waveguide. The optical interferometer has a polarization dependent frequency shift that is reduced by the heating of imparting the permanent refractive index changes.

### CROSS-REFERENCE TO RELATED APPLICATIONS

This application is a continuation of PCT International Application No. PCT/JP2012/055826 filed on Mar. 7, 2012, which claims the benefit of priority from the prior Japanese Patent Application No. 2011-066404 filed on Mar. 24, 2011. The entire contents of these applications are incorporated herein by reference.

### BACKGROUND OF THE INVENTION

1. Field of the Disclosure

The disclosure relates to an optical waveguide circuit and a method of manufacturing the same, and an optical waveguide circuit apparatus.

2. Description of the Related Art

In differential quadrature phase shift keying (DQPSK) or differential phase shift keying (DPSK) communication systems having a transmission rate of 40 Gbps, optical waveguide circuits, in which delay circuits are configured using waveguide type optical interferometers, such as Mach-Zehnder type interferometers (MZIs), are used as demodulation elements that demodulate DQPSK/DPSK optical signals. This type of demodulation elements has a very small permissible amount of polarization dependent frequency shift (PDFS) and the permissible amount is said to be approximately three to five degrees in terms of phase difference. PDFS is a phenomenon in which peaks in transmission characteristics generated by an optical interferometer differ between two polarization states (TM wave and TE wave) of light propagating in an optical waveguide.

The above-mentioned permissible amount of approximately three to five degrees corresponds to approximately 200 MHz to 300 MHz in terms of frequency for a 40 Gbps-DQPSK communication system using a delay circuit having a free spectral range (FSR) of 23 GHz, for example, and is extremely small. Various techniques for eliminating PDFS have been proposed (e.g., International Publication WO2008/084707; Japanese Patent Nos. 3703013, 2614365, 4405978, 2599488, and 3223959; and Japanese Patent Application Laid-open No. 2010-085906).

As a technique of eliminating PDFS, a technique of using a wave plate (azimuth rotator) has been disclosed. For example, in International Publication WO2008/084707, a technique is disclosed, which uses an azimuth rotator that is constituted of a half-wave plate with its principal axis of refractive index tilted by 45 degrees with respect to a principal surface of an optical waveguide substrate, and another half-wave plate (retarder) with its principal axis of refractive index in parallel with the principal surface of the optical waveguide substrate, and rotates the polarization state of input light just by 90 degrees or −90 degrees. By inserting such an azimuth rotator into an MZI interferometer, PDFS including influence by polarization-converted light generated in an optical coupler constituting the MZI interferometer is able to be eliminated.

As another technique of eliminating PDFS, a technique has been disclosed, which eliminates PDFS by locally heating an optical waveguide to permanently change its refractive index and birefringence. This technique is practical means for enabling highly accurate adjustment of PDFS and permanent maintenance of the adjusted characteristics, and is considered to be useful. Such permanent changing of the refractive index and the birefringence by heating the optical waveguide is sometimes called trimming.

For example, Japanese Patent No. 3703013 discloses a technique of controlling an adjustment amount of PDFS by trimming by forming a thin film heater on a chip of a planer lightwave circuit (PLC) and appropriately setting a region of an optical waveguide to be locally heated according to a structure thereof such as its heater width.

### SUMMARY

### Technical Problem

However, in order to respond to demands for higher transmission rates, an optical waveguide circuit that is able to more readily achieve a small PDFS and a manufacturing method thereof are increasingly being demanded.

Accordingly, there is a need to provide an optical waveguide circuit that is able to more readily achieve a small PDFS and a manufacturing method thereof, and an optical waveguide circuit apparatus that uses the optical waveguide circuit that is able to more readily achieve the small PDFS.

### SUMMARY OF THE INVENTION

According to an embodiment of the present invention, an optical waveguide circuit includes: an optical interferometer including an optical waveguide; and a heating unit that is disposed along at least a part of the optical waveguide included in the optical interferometer and performs heating of imparting, to the optical waveguide, reversible refractive index changes different from each other along two principal axes of refractive index of the optical waveguide and heating of imparting, to the optical waveguide, permanent refractive index changes different from each other along the two principal axes of refractive index of the optical waveguide, wherein the optical interferometer has a polarization dependent frequency shift that is reduced by the heating of imparting the permanent refractive index changes.

According to another embodiment of the present invention, an optical waveguide circuit apparatus includes: the optical waveguide circuit; and a controller that controls the heating unit.

According to yet another embodiment of the present invention, an optical waveguide circuit apparatus includes: the optical waveguide circuit, wherein the optical interferometer is configured to be approximately of a symmetrical shape with respect to a center thereof, a half-wave plate for reducing the polarization dependent frequency shift of the optical interferometer is inserted at an approximate center of the symmetrical shape, and two heating units are disposed with the half-wave plate interposed therebetween; and a controller that controls the heating unit, wherein the controller applies approximately equal powers to the two heating units that are disposed with the half-wave plate interposed therebetween and causes the heating units to perform the heating of imparting the reversible refractive index changes, when the optical waveguide circuit apparatus is used.

According to still another embodiment of the present invention, a method of manufacturing an optical waveguide circuit, which has an optical interferometer having an optical waveguide, includes: performing first heating of imparting reversible refractive index changes different from each other along two principal axes of refractive index of the optical waveguide to at least a part of the optical waveguide included in the optical interferometer; and performing second heating of imparting permanent refractive index changes different from each other along the two principal axes of refractive index of the optical waveguide to at least a part of the optical waveguide so as to reduce a polarization dependent frequency shift in the optical interferometer based on information on a refractive index change of the optical waveguide caused by the first heating of imparting the reversible refractive index changes.

The above and other objects, features, advantages and technical and industrial significance of this invention will be better understood by reading the following detailed description of presently preferred embodiment of the invention, when considered in connection with the accompanying drawings.

### BRIEF DESCRIPTION OF THE DRAWINGS

FIG. 1 is a schematic plan view of an optical waveguide circuit according to a first embodiment;

FIG. 2 is a cross-sectional view taken along line X-X of the optical waveguide circuit illustrated in FIG. 1;

FIG. 3 is a cross-sectional view taken along line Y-Y of the optical waveguide circuit illustrated in FIG. 1;

FIG. 4 is a graph illustrating a relation between heating amounts supplied by heaters and permanent amounts of change in refractive index of the optical waveguide for heaters of different widths;

FIG. 5 is a graph illustrating an example of a relation between heater power and amounts of change in inter-polarization phase difference;

FIG. 6 is a graph illustrating an example of a relation between cumulative trimming time and the amounts of change in inter-polarization phase difference;

FIG. 7 is a flow chart of an example of adjustment of PDFS;

FIG. 8 is a graph illustrating an example of wavelength dependence of PDFS in an initial state;

FIG. 9 is a graph illustrating an example of a relation between the heater power and PDFS at each wavelength when an arm optical waveguide is heated for reversible refractive index change;

FIG. 10 is a graph illustrating a relation between the cumulative trimming time and the PDFS at each wavelength;

FIG. 11 is a graph illustrating another example of the relation between the heater power and the PDFS at each wavelength when the arm optical waveguide is heated for reversible refractive index change;

FIG. 12 is a schematic plan view illustrating an optical waveguide circuit apparatus according to a second embodiment; and

FIG. 13 is a schematic plan view illustrating an optical waveguide circuit according to a third embodiment.

### DETAILED DESCRIPTION OF THE INVENTION

Embodiments of an optical waveguide circuit and a method of manufacturing the same, and an optical waveguide circuit apparatus according to the present invention are described in detail below with reference to the accompanying drawings. The embodiments do not limit the present invention. In the drawings, the same or corresponding elements are labeled with the same reference numerals as appropriate. In addition, it is to be noted that the drawings are schematic and relations between thicknesses and widths of each layer, ratios among layers, and the like may differ from those of the actual. Furthermore, portions having relations and ratios of dimensions that differ among the drawings may be included.

### First Embodiment

An optical waveguide circuit according to a first embodiment of the present invention is described below. The optical waveguide circuit according to the first embodiment is a PLC type optical waveguide circuit that may be used as a demodulation element for an optical DQPSK signal and is made of a silica-glass-based material.

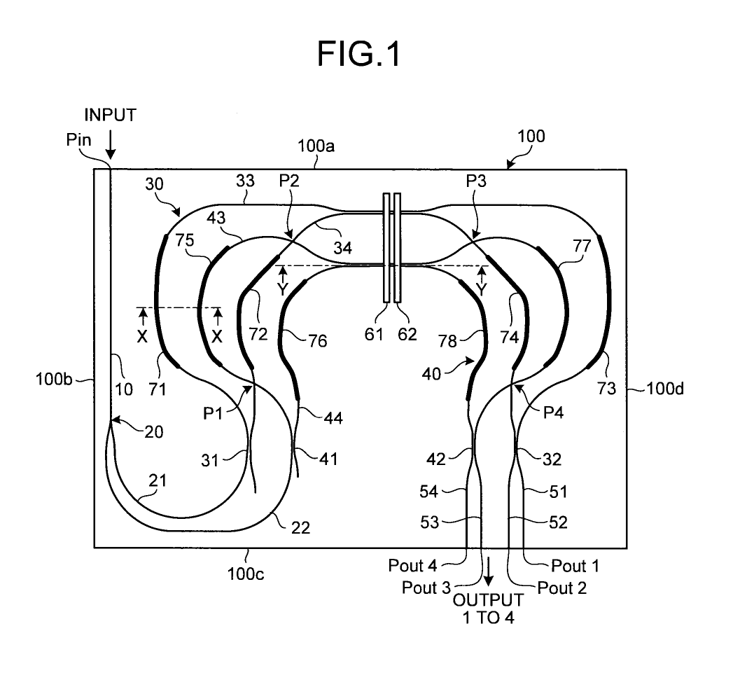

FIG. 1 is a schematic plan view of the optical waveguide circuit according to the first embodiment. As illustrated in FIG. 1, an optical waveguide circuit 100 includes an input optical waveguide 10, a Y-branched optical waveguide 20 connected to the input optical waveguide 10, MZI interferometers 30 and 40, output optical waveguides 51 to 54, half-wave plates 61 and 62, and heaters 71 to 78.

The input optical waveguide 10 is connected to an optical input port Pin formed closer to an edge face 100a and formed in an approximate straight line along an edge face 100b.

The Y-branched optical waveguide 20 includes branch optical waveguides 21 and 22. The branch optical waveguides 21 and 22 extend sequentially along the edge face 100b and an edge face 100c, bend and extend further toward the edge face 100a, and is generally U-shaped.

The MZI interferometer 30 is connected to the branch optical waveguide 21 of the Y-branched optical waveguide 20 and includes an input side coupler 31, an output side coupler 32, and arm optical waveguides 33 and 34 of different lengths that connect the input side coupler 31 and the output side coupler 32. The MZI interferometer 40 is connected to the branch optical waveguide 22 of the Y-branched optical waveguide 20 and includes an input side coupler 41, an output side coupler 42, and arm optical waveguides 43 and 44 of different lengths that connect the input side coupler 41 and the output side coupler 42.

Each of the input side couplers 31 and 41 and the output side couplers 32 and 42 is a two-input×two output 3 dB coupler having a directional coupler. One of input port sides of the input side coupler 31 or 41 is connected to the branch optical waveguide 21 or 22 of the Y-branched optical waveguide 20.

The arm optical waveguides 34 and 43 intersect at intersections P1 to P4. At each of the intersections P1 to P4, an intersection angle is adjusted such that light that has been waveguided through the respective arm optical waveguide 34 or 43 is waveguided as is through the same arm optical waveguide 34 or 43.

Each of the MZI interferometers 30 and 40 extends sequentially along the edge faces 100b, 100a, and an edge face 100d, is generally U-shaped, and is approximately symmetrically shaped with respect to the right and left of the sheet.

The output optical waveguides 51 and 52 are connected to the respective output ports of the output side coupler 32 of the MZI interferometer 30, while the output optical waveguides 53 and 54 are connected to the respective output ports of the output side coupler 42 of the MZI interferometer 40. The output optical waveguides 51 to 54 are connected respectively to optical output ports Pout1 to Pout4 formed on the edge face 100c.

The two arm optical waveguides 33 and 34 of the MZI interferometer 30 have an optical path length difference that delays a phase of an optical DQPSK signal propagating in the arm optical waveguide 33, which is the longer one, with respect to a phase of an optical DQPSK signal propagating in the arm optical waveguide 34, which is the shorter one, by a delay amount corresponding to one bit of a symbol rate (a time slot of one bit: one time slot). For example, when a transmission rate is 40 Gbps, the delay amount is 50 ps because each symbol rate of I channel and Q channel is 20 Gbps. As a result, light beams in neighboring time slots interfere with each other in the MZI interferometer 30. Similarly, the two arm optical waveguides 43 and 44 of the MZI interferometer 40 have an optical path length difference that delays a phase of an optical DQPSK signal propagating in the arm optical waveguide 43, which is the longer one, with respect to a phase of an optical DQPSK signal propagating in the arm optical waveguide 44, which is the shorter one, by a delay amount corresponding to one time slot. As a result, light beams in neighboring time slots interfere with each other in the MZI interferometer 40.

In addition, in the MZI interferometer 30, the optical path length difference is set longer than the delay amount corresponding to the above-described one bit by a length corresponding to π/4 of a phase of the optical signal. In the MZI interferometer 40, the optical path length difference is set shorter than the delay amount corresponding to the above-described one bit by the length corresponding to π/4 of the phase of the optical signal. As a result, the phase of light in neighboring time slots interfering with each other in the MZI interferometer 30 and the phase of light in neighboring time slots interfering with each other in the MZI interferometer 40 are shifted by π/4 and thus the MZI interferometer 30 and the MZI interferometer 40 have interference characteristics of which a phase difference is π/2.

The optical path length of the arm optical waveguide 34, which is the shorter one of the MZI interferometer 30, and the optical path length of the arm optical waveguide 44, which is the shorter one of the MZI interferometer 40, differ from each other. All of: the optical path lengths from the Y-branched optical waveguide 20 to the output optical waveguides 51 and 52 on the output side of the MZI interferometer 30 via the arm optical waveguide 34 of the MZI interferometer 30; and the optical path lengths from the Y-branched optical waveguide 20 to the output optical waveguides 53 and 54 on the output side of the MZI interferometer 40 via the arm optical waveguide 44 of the MZI interferometer 40, are approximately equal.

The half-wave plates 61 and 62 are disposed side by side approximately in parallel with each other, at an approximate center of left-right symmetry of the MZI interferometers 30 and 40, and across the arm optical waveguides 33, 34, 43, and 44. The half-wave plate 61 is disposed such that the principal axis thereof is tilted at 45 degrees with respect to a principal axis of refractive index of each of the arm optical waveguides 33, 34, 43, and 44. The half-wave plate 62 is disposed such that the principal axis thereof is parallel or horizontal with respect to the principal axis of refractive index of each of the arm optical waveguides 33, 34, 43, and 44.

The half-wave plate 61 has a function of replacing two orthogonal polarization states of input light (i.e., TE polarization and TM polarization along the principal axes of refractive index of the arm optical waveguide) with each other and a function of reducing PDFS. The half-wave plate 62 causes an interference condition of polarization-converted light to be the same as that of non-polarization-converted normal light even when polarization conversion occurs in the input side couplers 31 and 41, the output side couplers 32 and 42, and the like, and suppresses deterioration of PDFS due to the polarization conversion. As a result, PDFS is even more reduced, similarly as in International Publication WO2008/084707.

The heaters 71 to 78 are formed partially on and along the arm optical waveguides 33, 34, 43, and 44. The heaters 71 and 73 are disposed with the half-wave plates 61 and 62 interposed therebetween on the arm optical waveguide 33. The heaters 72 and 74 are disposed with the half-wave plates 61 and 62 interposed therebetween on the arm optical waveguide 34. The heaters 75 and 77 are disposed with the half-wave plates 61 and 62 interposed therebetween on the arm optical waveguide 43. The heaters 76 and 78 are disposed with the half-wave plates 61 and 62 interposed therebetween on the arm optical waveguide 44.

The heaters 71 to 78 are used: to perform trimming of the arm optical waveguides 33, 34, 43, and 44; and to impart reversible refractive index change, before this trimming, for examining in advance a direction of change and an amount of change in PDFS due to the trimming. PDFS is reduced by the half-wave plates 61 and 62. However, even if PDFS is reduced as such, because PDFS still exists, which is generated by design errors and manufacturing errors in the structure of each optical waveguide, manufacturing errors in the half-wave plates 61 and 62, or the like, trimming is performed to reduce this.

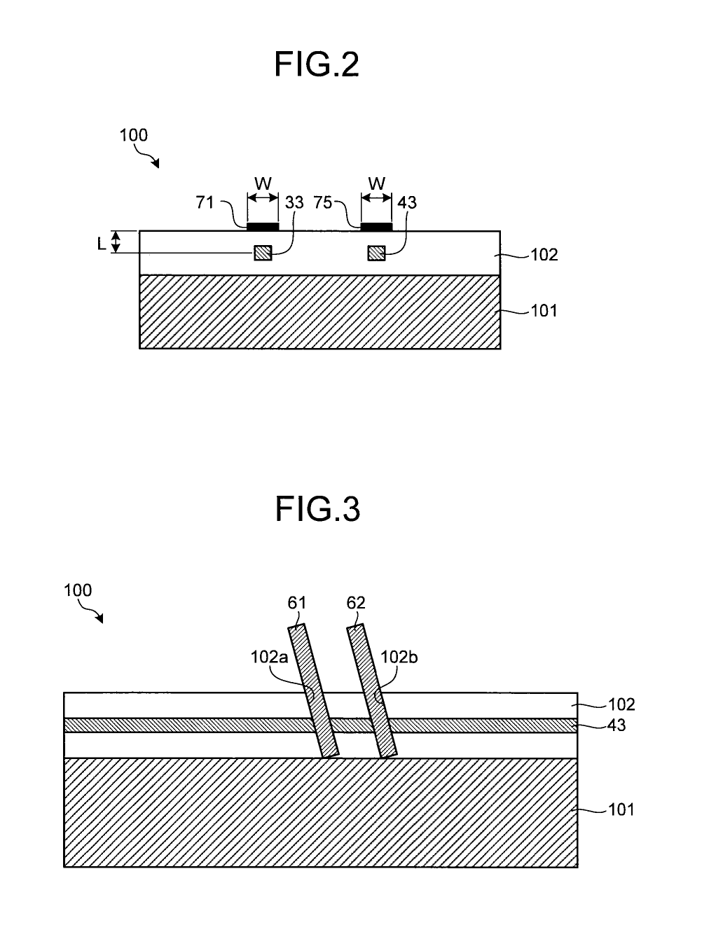

A cross-sectional configuration of the optical waveguide circuit 100 and the arrangement of the heaters 71 to 78 are described below with reference to FIG. 2. FIG. 2 is a cross-sectional view taken along line X-X of the optical waveguide circuit 100 illustrated in FIG. 1. As illustrated in FIG. 2, the optical waveguide circuit 100 is configured by forming, as optical waveguides, in a cladding layer 102 made of a silica-glass-based material formed on a substrate 101 made of silicon, core portions having a higher refractive index than that of the cladding layer, for example. FIG. 2 illustrates the cross-sectional surfaces of the arm optical waveguides 33 and 43. A relative refractive index difference of each optical waveguide with respect to the cladding layer 102 is 1.2%, for example. The cross-sectional surface of each optical waveguide has a size of 6 μm×6 μm, for example.

The heaters 71 and 75 illustrated in FIG. 2 are thin film heaters formed on the cladding layer 102, and made of a heater material such as a tantalum (Ta) based material. A width of each of the heaters 71 and 74 is denoted by W. A distance from the centers in a height direction of the arm optical waveguides 33 and 43 to the heaters 71 and 75 located above them is denoted by L. In the following description, the distance between a heater and an optical waveguide means the distance from the center of the optical waveguide in the height direction. A width of each of the other heaters 72 to 74 and 76 to 78 is also W and the distance from each of these heaters to a corresponding optical waveguide is also L. In the first embodiment, W is 50 μm, the thickness of the cladding layer 102 is approximately 60 μm, and L is approximately 17 μm.

The arrangement of the half-wave plates 61 and 62 is described below with reference to FIG. 3. FIG. 3 is a cross-sectional view taken along line Y-Y of the optical waveguide circuit 100 illustrated in FIG. 1. As illustrated in FIG. 3, the half-wave plates 61 and 62 are inserted into grooves 102a and 102b, respectively, formed in the cladding layer 102 across the arm optical waveguide 43 illustrated in FIG. 3 and the arm optical waveguides 33, 34, and 44, which are not illustrated in FIG. 3. The grooves 102a and 102b are tilted toward the extending direction of the arm optical waveguides 33, 34, 43, and 44 at approximately eight degrees with respect to a plane perpendicular to the arm optical waveguides 33, 34, 43, and 44. By this provision of the tilt in the grooves 102a and 102b, into which the half-wave plates 61 and 62 are inserted, when light propagating in the arm optical waveguides 33, 34, 43, and 44 is reflected by the surfaces of the half-wave plates 61 and 62, the reflected light is prevented from returning to the arm optical waveguides 33, 34, 43, and 44.

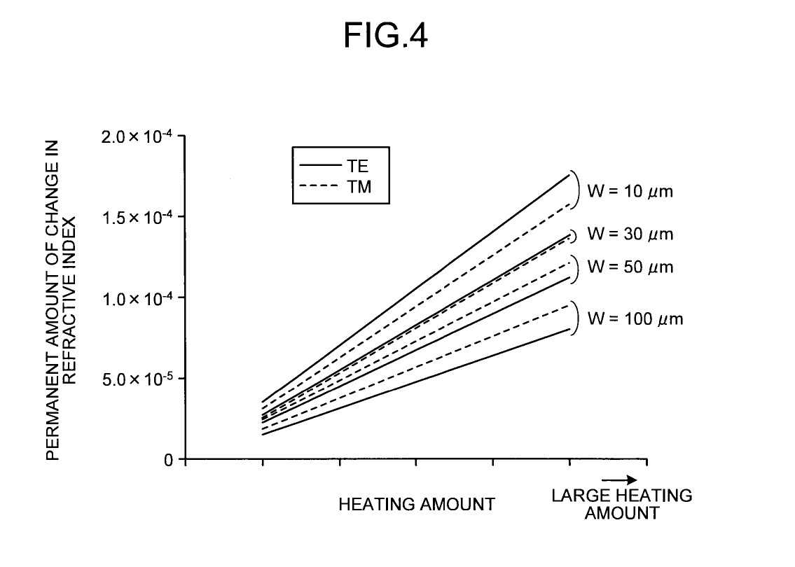

The width W of the heaters 71 to 78 and the distance between the heaters 71 to 78 and the respective arm optical waveguides 33, 34, 43, and 44 are described below. FIG. 4 is a graph illustrating a relation between heating amounts supplied by the heaters and permanent amounts of change in refractive index of the optical waveguide for each of the heaters of different widths.

As described in Japanese Patent No. 3703013, permanent amounts of change in refractive index that are trimmable by heaters have polarization dependence. That is, amounts of change in refractive index of an optical waveguide differ between TE polarization and TM polarization. In addition, polarization dependence differs depending on the width of the heater. FIG. 4 illustrates a case in which the distance L between the optical waveguides and the heaters is 17 μm and the width of the heaters is set in a range of 10 μm to 100 μm. In this case, there is nearly no difference in the amounts of change in refractive index between TE polarization and TM polarization when the width W is 30 μm, which is close to a value WO that is twice the distance L (i.e., polarization dependence is eliminated). The elimination of polarization dependence means that the difference in the amounts of change in refractive index between both polarizations is approximately 1% or less, for example. When W is larger than W0, the amount of change in refractive index for TM polarization is larger. When W is smaller than W0, the amount of change in refractive index for TE polarization is larger.

In the first embodiment, the width W of the heaters 71 to 78 is 50 μm, which is approximately 2.9 times the distance L. As a result, the amount of change in the refractive index is larger for TM polarization. For all of the widths, the amounts of change in refractive index are approximately proportional to the heating amounts.

A relation between heater power applied to the heaters 71 to 78 and amounts of change in inter-polarization phase difference of the arm optical waveguides 33, 34, 43, and 44 in the first embodiment are described below. The inter-polarization phase difference means an amount represented by converting the difference in the amounts of change in refractive index due to heating between TM polarization and TE polarization into a phase difference of light.

FIG. 5 is a graph illustrating an example of a relation between the heater power and the amounts of change in inter-polarization phase difference in the first embodiment. The amounts of change in inter-polarization phase difference are normalized with 7c. When the optical waveguides are heated with the heater power of 0 to 500 mW illustrated along the horizontal axis, heat of a degree that allows the refractive index to change reversibly by a thermo-optic effect (TO effect) is applied to the optical waveguides, unlike the permanent refractive index change in the case of trimming.

As illustrated in FIG. 5, in the first embodiment, the heater power and the amounts of change in inter-polarization phase difference are approximately proportional to each other due to the TO effect, and the larger the heater power is set, the larger the amount of change in inter-polarization phase difference becomes. This means that when the heaters 71 to 78 of the first embodiment apply heat of a degree that allows the refractive index to reversibly change due to the TO effect to the arm optical waveguides 33, 34, 43, and 44, the more increased the heater power is, the greater the amount of change in inter-polarization phase difference becomes because the amount of change in refractive index of TM polarization is larger similarly to the permanent refractive index change illustrated in FIG. 4.

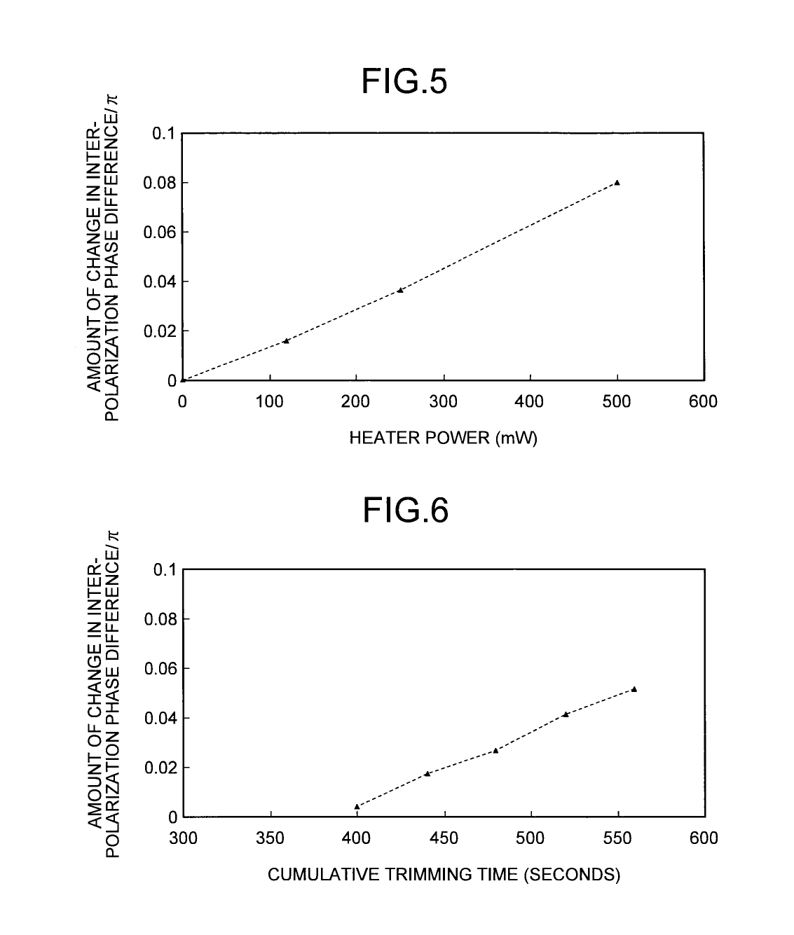

FIG. 6 is a graph illustrating an example of a relation between cumulative trimming time and the amounts of change in inter-polarization phase difference in the first embodiment. The cumulative trimming time means an accumulated period of time during which heat of a degree that allows the refractive index to permanently change is applied to the arm optical waveguides. In FIG. 6, the heater power is 6 W. As illustrated in FIG. 6, the cumulative trimming time and the amounts of change in inter-polarization phase difference are approximately proportional to each other. In addition, as illustrated in FIG. 4, in the first embodiment, the larger the heater power is, the larger the amount of change in inter-polarization phase difference because the amount of change in refractive index in TM polarization is large.

As illustrated in FIGS. 4 to 6, there is a correlation between the amounts of change in inter-polarization phase difference due to a heat quantity that reversibly changes the refractive index by the TO effect and the amounts of change in inter-polarization phase difference due to the permanent amounts of change in refractive index in the trimming. In a method of manufacturing the optical waveguide circuit 100 according to the first embodiment, which is described below, information on the refractive index change is obtained by generating the reversible refractive index change due to the TO effect before performing the trimming on the arm optical waveguides 33, 34, 43, and 44 by the heaters 71 to 78, and a direction of change and an amount of change in PDFS due to the trimming is thereby examined in advance.

An example of the method of manufacturing the optical waveguide circuit 100 according to the first embodiment is described below. First, deposition of glass fine particles by a known flame hydrolysis deposition (FHD) method, a vitrification process, photolithography, reactive ion etching, the FHD method, and the vitrification process are sequentially performed to form the structure of each optical waveguide illustrated in FIG. 1 on the substrate 101. Thereafter, the heaters 71 to 78 are formed by a sputtering method or the like, the grooves 102a and 102b are formed by etching or the like, and the half-wave plates 61 and 62 are inserted. As a result, the configuration of the optical waveguide circuit 100 illustrated in FIG. 1 is formed.

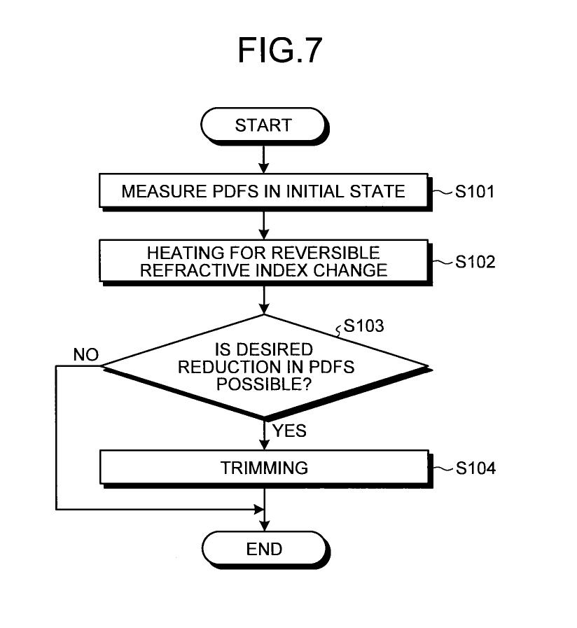

Next, PDFS is adjusted. FIG. 7 is a flow chart of an example of the adjustment of PDFS. As illustrated in FIG. 7, in this adjustment method, PDFS in an initial state after the configuration of the optical waveguide circuit 100 is formed is measured (step S101). Next, the arm optical waveguides are heated for reversible refractive index change on the basis of results of the measurement at step S101 (step S102). Next, whether a desired reduction in PDFS is possible is determined on the basis of the change in PDFS due to the heating at step S102 (step S103). If the desired reduction in PDFS is possible (Yes at step S103), trimming is performed (step S104). If the desired reduction in PDFS is not possible (No at step S103), defectiveness is determined and the process ends.

An exemplary case is described below in which an optical waveguide circuit formed of the configuration of the optical waveguide circuit 100 is actually manufactured by the above-described method and the adjustment thereof is performed.

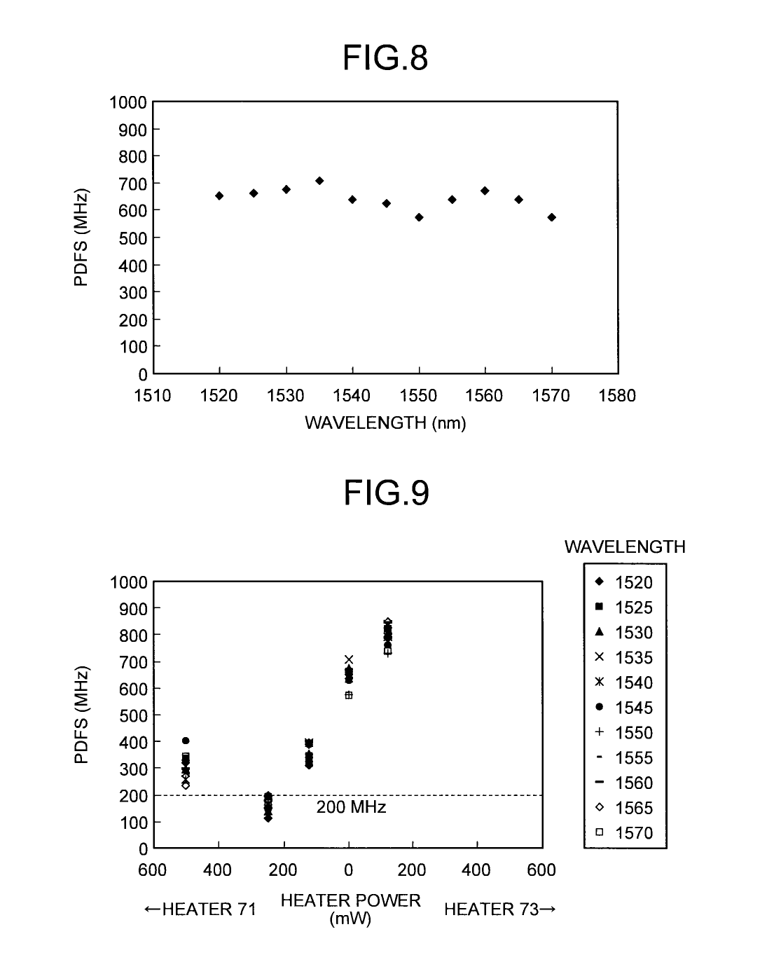

First, the process at step 5101 is described. In this process, a transmission spectrum of the MZI interferometer 30 was measured and PDFS was found at wavelength peaks every approximately 5 nm in a wavelength bandwidth of approximately 1520 nm to 1570 nm including C band. FIG. 8 is a graph illustrating an example of wavelength dependence of PDFS in the initial state. As illustrated in FIG. 8, PDFS of 600 MHz to 700 MHz remained in the measured bandwidth despite the insertion of the half-wave plates 61 and 62.

Next, the arm optical waveguide 33 was heated for the reversible refractive index change of step S102 as described below using the heaters 71 and 72, before trimming was performed using the heaters 71 and 73 disposed symmetrically with the half-wave plates 61 and 62 interposed therebetween on the arm optical waveguide 33, based on these results of measurement.

First, transmission spectra were measured respectively while electricity was conducted through the heaters 71, 73 individually with powers of 120 mW, 250 mW, and 500 mW, and PDFS was found. As illustrated in FIG. 5, these powers impart heat of a degree that allows the refractive index to reversibly change by the TO effect to the arm optical waveguide 33.

FIG. 9 is a graph illustrating an example of a relation between the heater power and PDFS at each wavelength when the arm optical waveguide was heated for the reversible refractive index change. As illustrated in FIG. 9, it was confirmed that PDFS increased as the heater power of the heater 73 was increased. In contrast, it was confirmed that PDFS decreased once and increased thereafter as the heater power of the heater 71 was increased. On the basis of the results illustrated in FIG. 9, the determination at step S103 was performed, and it was determined that PDFS was able to be minimized to 200 MHz or less by conducting electricity of the power of 250 mW through the heater 71, i.e., that a desired reduction in PDFS was possible. From this result, it was decided to perform the trimming using the heater 71.

Trimming time upon the trimming using the heater 71 was estimated from the correlations illustrated in FIGS. 5 and 6. Specifically, it was understood from FIG. 5 that the amount of change in inter-polarization phase difference was approximately 0.035π when electricity of 250 mW was conducted through the heater. It was understood from FIG. 6 that the cumulative trimming time to generate the amount of change in inter-polarization phase difference of approximately 0.035π was approximately 500 seconds. Therefore, the cumulative trimming time necessary for achieving the amount of change in inter-polarization phase difference of approximately 0.035π was estimated to be approximately 500 seconds in order to reduce PDFS to 200 MHz or less.

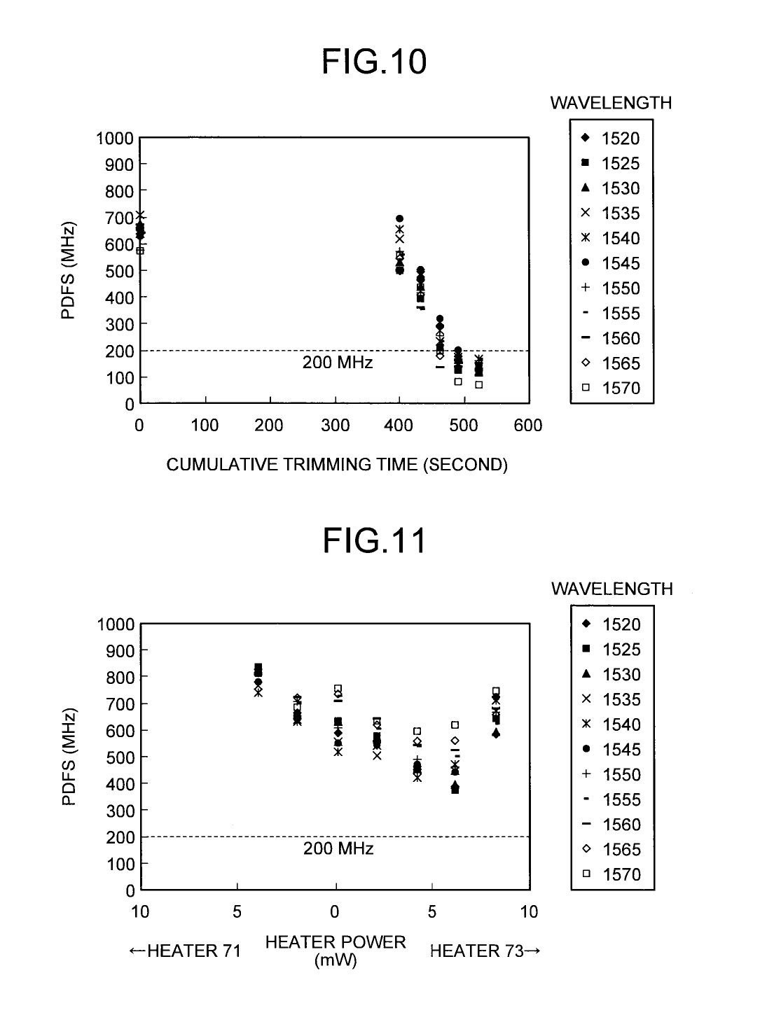

Next, the trimming of step S104 was performed. FIG. 10 is a graph illustrating a relation between the cumulative trimming time and PDFS at each wavelength. In FIG. 10, first as an experiment, PDFS was measured after the trimming for 400 seconds was continuously performed by setting the heater power to 6 W. Subsequently, additional trimming was performed with the same heater power every 30 seconds. As a result, a desired PDFS equal to or less than 200 MHz, more specifically equal to or less than 150 MHz, was achieved in the cumulative trimming time of approximately 500 seconds, which had been estimated from the results of the heating for reversible refractive index change.

Next, when the processes of steps S101 to S104 were applied using the heaters 75 and 77 corresponding to the arm optical waveguide 43 to the MZI interferometer 40, a PDFS equal to or less than 150 MHz was achieved. That is, by the above adjustment, the optical waveguide circuit having the PDFS equal to or less than 150 MHz was able to be realized, which is applicable to a 40 Gbps-DQPSK communication system.

When trimming is performed without applying the above-described adjustment method, the trimming may be adversely performed by the heater 73. If this happens, PDFS will be caused to increase as illustrated in FIG. 9. The trimming generates permanent refractive index change and thus such an increase in PDFS causes the optical waveguide circuit to be defective. Furthermore, even when trimming is performed by the heater 71, an excess in cumulative trimming time may cause PDFS to increase to a value greater than the minimum value.

In contrast, an unnecessary increase in PDFS is prevented by determining the heater to perform trimming and cumulative trimming in advance using the above adjustment method and thus a manufacturing yield of the optical waveguide circuit is increased.

In the above adjustment method, heating of the arm optical waveguide 33 for reversible refractive index change is performed by the heaters 71 and 73, but heating of the arm optical waveguide 34 for reversible refractive index change may be performed by the heaters 72 and 74 by a similar method. In addition, heating of the arm optical waveguide 44 for reversible refractive index change may be performed by the heaters 76 and 78 by a similar method.

Next, the processes at steps S101 and S102 were applied to another optical waveguide circuit manufactured similarly as described above. FIG. 11 is a graph illustrating another example of the relation between the heater power and PDFS at each wavelength when arm optical waveguides were heated for reversible refractive index change. In this case, as illustrated in FIG. 11, PDFS was equal to or greater than 400 MHz and could not be made equal to or less than 200 MHz when electricity was conducted through either of heaters 71 and 73. Similarly, when electricity was conducted through the heaters 72 and 74, PDFS equal to or less than 200 MHz was not achievable either. Therefore, it was determined that a desired reduction in PDFS was not possible in the process at step S103, and the process was ended without performing the process at step S104. As a result, a defective optical waveguide circuit, with which a desired reduction in PDFS was not possible by performing the trimming, was efficiently identified, and unnecessary trimming steps thereafter were omittable.

### Second Embodiment

A second embodiment of the present invention is described below. An optical waveguide circuit apparatus according to the second embodiment includes the optical waveguide circuit according to the first embodiment.

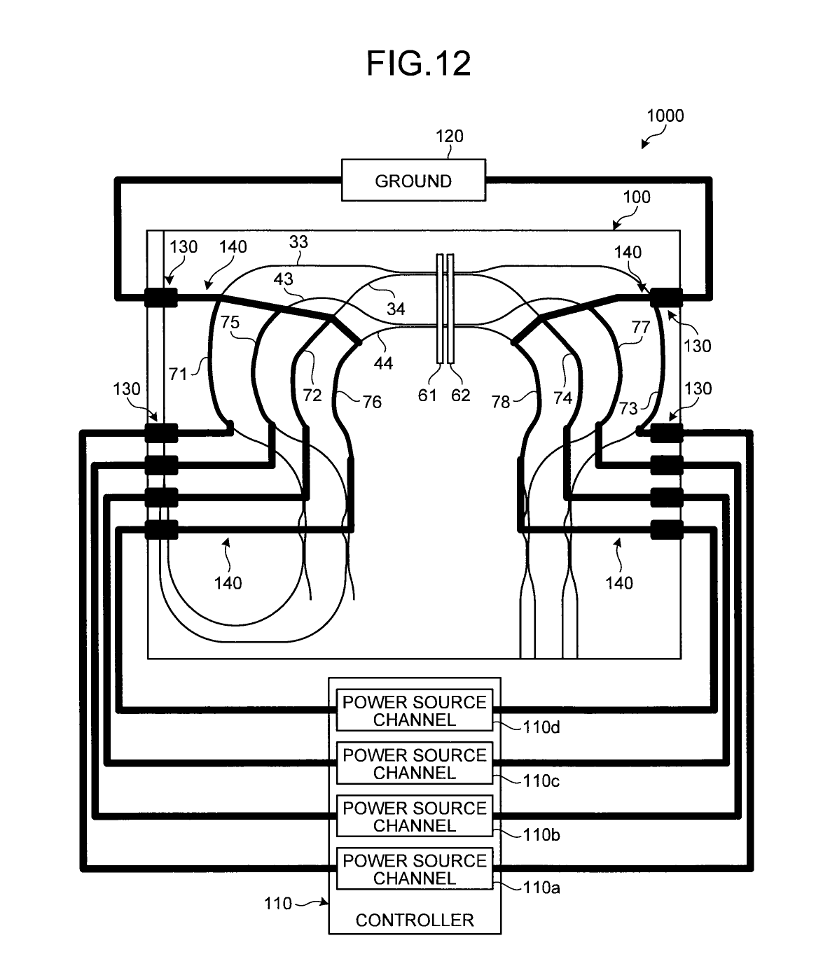

FIG. 12 is a schematic plan view of the optical waveguide circuit apparatus according to the second embodiment. As illustrated in FIG. 12, an optical waveguide circuit apparatus 1000 includes the optical waveguide circuit 100 according to the first embodiment illustrated in FIG. 1, a controller 110 that connects to each of the heaters 71 to 78 of the optical waveguide circuit 100, and a ground terminal 120.

Terminals 130 and wiring 140 for connecting the heaters 71 to 78 to the controller 110 and to the ground terminal 120 are formed on the optical waveguide circuit 100.

The controller 110 includes power source channels 110a to 110d that supply power to the heaters 71 to 78. The power source channel 110a connects to an end of each of the heaters 71 and 73 disposed on the same arm optical waveguide 33. The power source channel 110b connects to an end of each of the heaters 75 and 77 disposed on the same arm optical waveguide 43. The power source channel 110c connects to an end of each of the heaters 72 and 74 disposed on the same arm optical waveguide 34. The power source channel 110d connects to an end of each of the heaters 76 and 78 disposed on the same arm optical waveguide 44. The ground terminal 120 connects to the other end of each of the heaters 71 to 78.

In the optical waveguide circuit 100 of the optical waveguide circuit apparatus 1000, PDFS is reduced by the above-described adjustment method. However, interference characteristics of the optical waveguide circuit 100 change in accordance with a wavelength of an input optical DQPSK signal, for example. Accordingly, in order to achieve desired interference characteristics at a wavelength of an input optical DQPSK signal upon use of this optical waveguide circuit apparatus 1000, heat is applied to the arm optical waveguides 33, 34, 43, and 44 by the heaters 71 to 78, so that refractive index is adjusted by the TO effect.

The width W of the heaters 71 to 78 and the distance from the heaters 71 to 78 to the arm optical waveguides 33, 34, 43, and 44 are set, for example, such that polarization dependence, i.e., inter-polarization phase difference, is generated in the TO effect, for examining PDFS before trimming. However, it is preferable that polarization dependence is not generated in the TO effect when the refractive index is adjusted by the TO effect upon the use as described above.

Therefore, in the optical waveguide circuit apparatus 1000, the two heaters disposed with the half-wave plates 61 and 62 interposed therebetween on the same arm optical waveguide are connected in parallel with the same power source channel such that equal power is applicable. As a result, the inter-polarization phase difference generated in the arm optical waveguide 33 when power is applied to the heater 71 and the inter-polarization phase difference generated in the arm optical waveguide 33 when power is applied to the heater 73 are cancelled by the half-wave plates 61 and 62, for example. Consequently, the optical waveguide circuit apparatus 1000 has a high manufacturing yield and is able to appropriately adjust the refractive index without polarization dependence upon use.

From the above reason, it is preferable that the two heaters that are disposed with the half-wave plates 61 and 62 interposed therebetween on the same arm optical waveguide are not simultaneously driven but only one of them is driven upon examination of the optical waveguide circuit 100 before trimming. By driving only one of them, the generated inter-polarization phase difference is not cancelled, and thus the examination before trimming becomes easy.

In the optical waveguide circuit apparatus 1000, the heaters to be applied with the same power are connected in parallel but the present invention is not limited thereto and equal power may be individually applied to each heater.

### Third Embodiment

A third embodiment of the present invention is described below. An optical waveguide circuit according to the third embodiment includes heaters imparting a TO effect to arm optical waveguides and heaters performing trimming, which are separately provided to the heaters imparting the TO effect.

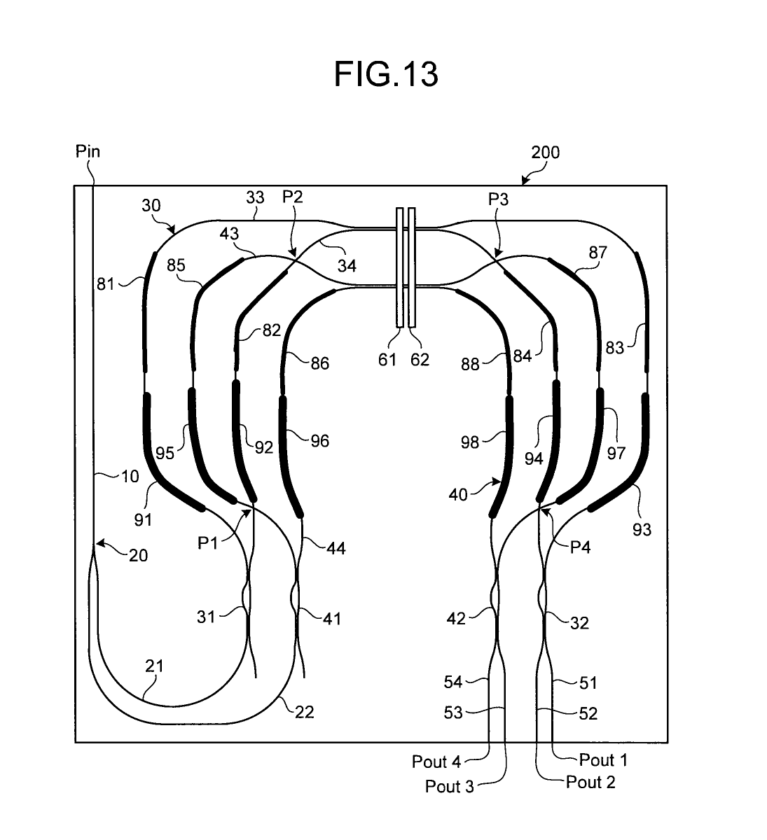

FIG. 13 is a schematic plan view of the optical waveguide circuit according to the third embodiment. As illustrated in FIG. 13, an optical waveguide circuit 200 has a configuration of the optical waveguide circuit 100 according to the first embodiment illustrated in FIG. 1, from or to which the heaters 71 to 78 are removed, heaters 81 to 88 for imparting the TO effect are added, and heaters 91 to 98 for the trimming are added.

The heaters 81 and 91 are disposed on the arm optical waveguide 33 on a side of the input optical waveguide 10 with respect to the half-wave plates 61 and 62. The heaters 83 and 93 are disposed on the arm optical waveguide 33 on a side of the output optical waveguides 51 to 54 with respect to the half-wave plates 61 and 62.

The heaters 82 and 92 are disposed on the arm optical waveguide 34 on the side of the input optical waveguide 10 with respect to the half-wave plates 61 and 62. The heaters 84 and 94 are disposed on the arm optical waveguide 34 on the side of the output optical waveguides 51 to 54 with respect to the half-wave plates 61 and 62.

Likewise, the heaters 85 and 95 and the heaters 86 and 96 are disposed on the arm optical waveguides 43 and 44 respectively, on the side of the input optical waveguide 10 with respect to the half-wave plates 61 and 62. The heaters 87 and 97 and the heaters 88 and 98 are disposed on the arm optical waveguides 43 and 44 respectively, on the side of the output optical waveguides 51 to 54 with respect to the half-wave plates 61 and 62.

Upon adjustment of PDFS in the optical waveguide circuit 200, if the PDFS is able to be reduced by conducting electricity through the heater 81 on the arm optical waveguide 33 of the MZI interferometer 30, trimming is performed by the heater 91 disposed on the same input optical waveguide 10 side with respect to the half-wave plates 61 and 62. As described, by performing the preliminary examination and the trimming using the heaters disposed on the same arm optical waveguide on the same side with respect to the half-wave plates 61 and 62 as a pair, good PDFS is obtainable by a single trimming heater, similarly to the first embodiment.

In the optical waveguide circuit 200, because the heaters for the trimming and the heaters for imparting the TO effect are configured separately, each heater is able to be designed into an appropriate configuration and with an appropriate arrangement according to its usage. For example, the heaters for the trimming and the heaters for imparting the TO effect may have the same configuration or different configurations. Regardless of the configurations of the heaters, correlations between amounts of change in inter-polarization phase difference for the heaters for the trimming and for the heaters for imparting the TO effect as illustrated in FIGS. 5 and 6 may be examined in advance, and good trimming similar to the first embodiment is able to be performed using the correlations.

In the above embodiment, to readily determine the heater to perform the trimming, the configuration is employed in which the heaters for trimming and the heaters for imparting the TO effect impart the inter-polarization phase difference changes in the same direction (sign) when power is applied. The present invention, however, is not limited to this and a heater may have any configuration as long as the configuration generates the inter-polarization phase difference changes for both cases of imparting the reversible TO effect and performing the trimming.

For example, a configuration may be employed by which a reverse inter-polarization phase difference change (i.e., the amount of change in refractive index is larger for TE polarization) is imparted with a method of selecting structural parameters such as the width of the heaters and trimming parameters such as power applied for the trimming. In such a case, which heater for trimming is able to impart the same inter-polarization phase difference change when which heater imparts the TO effect may be found beforehand and a heater to be used in the trimming may be determined according to this finding, like determining, in the case of the optical waveguide circuit 100 in the first embodiment, when PDFS is reducible by imparting the TO effect to the arm optical waveguide 33 by the heater 71, to perform trimming by the heater 73 on the opposite side with the half-wave plates 61 and 62 interposed therebetween.

In the above embodiment, any one of the plural heaters is used in the trimming, but the present invention is not limited to this, and the plural heaters may be driven simultaneously or consecutively to perform the trimming. In this case, the heater to be used and the trimming amount in the trimming may be determined by preliminarily adjusting the reversible inter-polarization phase difference by the TO effect similarly to the above embodiment.

In the above embodiment, the optical waveguide circuit is a demodulation element for the optical DQPSK signals. The present invention, however, is not limited to this and is applicable to an optical waveguide circuit having various kinds of optical interferometers. Particularly, for a configuration in which TM polarization and TE polarization are replaced with each other by inserting a half-wave plate in an optical interferometer, it is difficult to determine which of TM polarization and TE polarization a peak appearing in an interference waveform is and thus it is effective to examine in advance a direction of trimming by imparting a reversible TO effect before trimming of the optical waveguide circuit.

According to an embodiment of the disclosure, an optical waveguide circuit that achieves a small PDFS more readily is able to be realized.

The above-described embodiments do not limit the present invention. Any configuration obtained by combining as appropriate the elements of the embodiments is also included in the present invention. For example, the optical waveguide circuit according to the third embodiment may be used in the optical waveguide circuit apparatus according to the second embodiment. Other embodiments, examples, and operation techniques carried out by persons skilled in the art on the basis of the above-described embodiments are all included in the present invention.

What is claimed is:

1. An optical waveguide circuit, comprising:
an optical interferometer including an optical waveguide; and
a heating unit that is disposed along at least a part of the optical waveguide included in the optical interferometer and performs heating of imparting, to the optical waveguide, reversible refractive index changes different from each other along two principal axes of refractive index of the optical waveguide and heating of imparting, to the optical waveguide, permanent refractive index changes different from each other along the two principal axes of refractive index of the optical waveguide, wherein
the optical interferometer has a polarization dependent frequency shift that is reduced by the heating of imparting the permanent refractive index changes.

2. The optical waveguide circuit according to claim 1, wherein the heating unit includes a heater.

3. The optical waveguide circuit according to claim 1, wherein the heating unit includes a heater imparting the reversible refractive index changes and another heater imparting the permanent refractive index changes.

4. The optical waveguide circuit according to claim 2, wherein a width of the heater and a distance from the heater to the optical waveguide are set so as to impart the refractive index changes different from each other along the two principal axes of refractive index of the optical waveguide.

5. The optical waveguide circuit according to claim 3, wherein a width of the heater and a distance from the heater to the optical waveguide are set so as to impart the refractive index changes different from each other along the two principal axes of refractive index of the optical waveguide.

6. The optical waveguide circuit according to claim 1, wherein the optical interferometer is a Mach-Zehnder type interferometer.

7. The optical waveguide circuit according to claim 1, wherein the optical waveguide circuit is configured as a demodulation element that demodulates an optical differential phase shift keying signal.

8. The optical waveguide circuit according to claim 1, wherein the permanent refractive index changes are imparted based on information on a refractive index change of the optical waveguide when the reversible refractive index changes are imparted.

9. The optical waveguide circuit according to claim 8, wherein the information on the refractive index change is the polarization dependent frequency shift of the optical interferometer.

10. The optical waveguide circuit according to claim 1, wherein
the optical interferometer is configured to be approximately of a symmetrical shape with respect to a center thereof, and
a half-wave plate for reducing the polarization dependent frequency shift of the optical interferometer is inserted at an approximate center of the symmetrical shape.

11. The optical waveguide circuit according to claim 10, wherein the polarization dependent frequency shift of the optical interferometer at a predetermined wavelength is equal to or less than 200 MHz.

12. The optical waveguide circuit according to claim 10, wherein two heating units are disposed with the half-wave plate interposed therebetween.

13. An optical waveguide circuit apparatus, comprising:
the optical waveguide circuit according to claim 1; and
a controller that controls the heating unit.

14. An optical waveguide circuit apparatus, comprising:
the optical waveguide circuit according to claim 12; and
a controller that controls the heating unit, wherein
the controller applies approximately equal powers to the two heating units that are disposed with the half-wave plate interposed therebetween and causes the heating units to perform the heating of imparting the reversible refractive index changes, when the optical waveguide circuit apparatus is used.

15. A method of manufacturing an optical waveguide circuit comprising an optical interferometer including an optical waveguide, the method comprising:
performing first heating of imparting reversible refractive index changes different from each other along two principal axes of refractive index of the optical waveguide to at least a part of the optical waveguide included in the optical interferometer; and
performing second heating of imparting permanent refractive index changes different from each other along the two principal axes of refractive index of the optical waveguide to at least a part of the optical waveguide so as to reduce a polarization dependent frequency shift in the optical interferometer based on information on a refractive index change of the optical waveguide caused by the first heating of imparting the reversible refractive index changes.

16. The method of manufacturing an optical waveguide circuit according to claim 15, wherein the information on the refractive index change is the polarization dependent frequency shift in the optical interferometer.

17. The method of manufacturing an optical waveguide circuit according to claim 15, wherein the second heating is performed such that the polarization dependent frequency shift in the optical interferometer at a predetermined wavelength becomes equal to or less than 200 MHz.

18. The method of manufacturing an optical waveguide circuit according to claim 15, wherein a region of the optical waveguide on which the second heating is to be performed and a heating amount thereof are set based on a correlation between an amount of change in inter-polarization phase difference based on the refractive index changes when the first heating is performed and an amount of change in inter-polarization phase difference based on the refractive index changes when the second heating is performed.
